(19) United States
(12) Patent Application Publication
(10) Pub. No.: US 2024/0192030 A1
(43) Pub. Date: Jun. 13, 2024

(54) POSITION SENSOR FOR BEARINGLESS SLICE MOTORS

(71) Applicant: Massachusetts Institute of Technology, Cambridge, MA (US)

(72) Inventors: Krishan Kant, Cambridge, MA (US); David L. Trumper, Plaistow, NH (US)

(73) Assignee: Massachusetts Institute of Technology, Cambridge, MA (US)

(21) Appl. No.: 18/532,118

(22) Filed: Dec. 7, 2023

Related U.S. Application Data
(60) Provisional application No. 63/386,441, filed on Dec. 7, 2022.

(51) Int. Cl. G01D 5/20; G01B 7/30

(52) U.S. Cl. CPC G01D 5/20; G01B 7/30

(57) ABSTRACT

A position sensor with six degrees of freedom (DoF) measurement capability may be used for position sensing of the rotor in a bearingless slice motor to enable active control. The sensor is designed to fit entirely under the rotor and operates by accessing the rotor bottom surface only, enabling packaging of the pump on the top of the rotor. The sensor has two parts; both operate using eddy currents. One of these parts measures the two radial DoF of the rotor. The other part measures the axial, angular rotation and tip/tilt DoF. The sensor utilizes a conductive target fixed to the underside of the rotor. The design and fabrication of the sensor along with the signal processing methods are described.

### CROSS-REFERENCE TO RELATED APPLICATIONS

This application claims the benefit under 35 U.S.C. § 119 of U.S. Provisional Patent Application No. 63/386,441 filed on Dec. 7, 2022, which is hereby incorporated by reference herein in its entirety.

### STATEMENT REGARDING FEDERALLY SPONSORED RESEARCH

This invention was made with government support under HL134455 awarded by the National Institutes of Health. The government has certain rights in the invention.

### BACKGROUND

Magnetic bearings and bearingless motors require associated sensors that can be accommodated within the device structures where the measurement is required, and which allow space for other functions such as pumping while meeting the feedback control requirements of the devices. Bearingless slice motors have both passively stable degrees of freedom (DoF) which require no active control and unstable DoF which require active control to stabilize. Slice motors may have either a temple stator design or a normal stator design. In the controlled DoF, real-time position measurements may be required. Measurements in the passively stable DoF may be desirable for monitoring rotor motions.

### SUMMARY

Bearingless slice motors require measurements of three (3) controlled degrees of freedom (DoF) (X, Y, θ_{Z}) for closed-loop control and for some applications may require measurements of three (3) other DoF (Z, θ_{X}, θ_{Y}) for monitoring. For example, such monitoring may be useful in centrifugal pump applications where the impeller faces disturbances in different directions while pumping. Monitoring the additional DoF can provide a better understanding of the system and/or be useful for troubleshooting.

A sensor can be analyzed based on its functionality for control and for monitoring. Closed-loop position control specifications of bearingless motors impose a bandwidth requirement on the corresponding sensors. Conversely, for monitoring sensors, the noise and bandwidth requirement may be less important. For bearingless motors, levitation is achieved using stator winding flux, which acts against the attraction between the rotor and stator. This attraction between stator and rotor, mostly due to the permanent magnets in the motor, is an unstable phenomenon defined by negative magnetic stiffness. The speed of levitation position control must be fast enough to counter this unstable attraction deflecting the rotor from the equilibrium point at the center of the stator bore. This phenomenon defines the bandwidth of the position control and, in general, position sensor bandwidth should be significantly greater than position control bandwidth (e.g., close to or larger than 10 times as great).

Along with the levitation/position control, a motor also requires speed control. For a bearingless slice motor, speed control may be similar to the vector control of permanent magnet motors, which requires the rotor angular position measurement. For pump applications, a high bandwidth speed control is not required. Thus the angle sensor bandwidth requirement may be relatively low.

Another requirement for a sensor may be to have decoupled measurements among various degrees of freedom. In the context of a slice motor, an important measurement is the radial motion (X & Y), thus it may be important that motions in other DoFs do not significantly affect radial measurements. The radial measurements are required to be decoupled from rotation, tilt and axial motions.

One way to measure the rotor position is to measure the rotor face at the airgap, which has motion in the normal direction to the face of the sensor. However, in this case, the sensor must be placed in the stator and rotor plane. For larger motors, there is typically enough space to accommodate sensors in the stator plane, but for smaller motors this space is usually tight or not available. For some applications, such as pump applications, it may be a requirement that the sensor be designed such that it can fit under the rotor to enable packaging of the pump rotor and housing.

Various kinds of sensors are available commercially which can be used as position sensors, such as hall effect, eddy current, and optical sensors. Hall effect sensors are relatively compact, but if placed near the motor airgap, they will pick up the stator winding flux and thus may provide inaccurate measurements. Eddy current sensors are typically larger in size and again placing them near the stator can reduce the sensitivity due to presence of ferromagnetic steel in proximity. Depending on the cored or coreless configuration of eddy current sensors, the measurement will be affected by the magnetic field generated during the motor operation as well. Moreover, slice motors usually have a large air gap to allow for the pump housing and flow path, making a radial sensor design more challenging. In one variation of eddy current sensors, printed circuit board (PCB) coils are used to excite and differentially measure the induced voltage in coils. The position of a shaft passing through the sensor varies the induced voltages, and thus gives a position measurement.

Optical sensors have also been proposed, as they are unaffected by the magnetic fields and are relatively smaller in size. However, for some applications they are difficult to use, e.g., if a smooth reflecting surface is not available, or there is an opaque housing or fluid that blocks light transmission to the rotor. Another category of sensors are inductance-to-digital converters, which utilize varying inductance of a coil as a measure of position. The limitations of these sensors are the same as the eddy current sensors, thus these must be placed in the motor considering above mentioned factors. There is a need for sensors that do not need to be placed directly in line with the motion.

Described herein are radial position sensors that can measure the rotor position in a shear mode and achieve necessary resolution and bandwidth (e.g., 1 kHz bandwidth with 1.2 μm resolution) to enable active control in various pumping applications. According to some embodiments, a two-part 6-DoF position sensor works on the principle of eddy currents (measuring the magnetic flux under the rotor is not an option for magnet-less rotors). The sensor is designed to fit under the rotor in a bearingless slice motor, which makes it more space efficient, less sensitive to the stray magnetic flux around the airgap and allows measurements from motion in a shear mode. This sensor provides the capability to measure all six (6) DoF by accessing the rotor bottom surface only, enabling packaging of a pump on the top of the rotor. The sensor has two parts; both operate using eddy currents. One of these parts measures the two radial DoF of the rotor. The other part measures the axial, angular rotation and tip/tilt DoF. The sensor utilizes a conductive target fixed to the underside of the rotor. The design and fabrication of the sensor along with the signal processing methods are described herein. The general sensing principles presented herein are applicable to multi-axis motion sensing in a broad range of motion control, including bearingless pumps.

Sensors disclosed herein may be used to measure the rotor position of various types of motors, including but not limited to motors described in U.S. Provisional Patent Application No. 63/430,856 filed on Dec. 7, 2022, and entitled “Bearingless Split Teeth Flux Reversal Motor,” the entire contents of which is hereby incorporated by reference.

According to one aspect of the present disclosure, a position sensor configured to sense information about a position of a rotor includes: a first part comprising a plurality of coils, the first part configured to make radial measurements related to the rotor; and a second part comprising a plurality of coils, the second part configured to make rotation, tilt, and axial measurements related to the rotor. The position sensor is configured to fit underneath the rotor.

In some embodiments, the position sensor can be a 6-degrees of freedom (DoF) position sensor. In some embodiments, the rotor may be part of a bearingless slice motor. In some embodiments, the position sensor can be configured to interact with a conductive target affixed to the rotor. In some embodiments, the conductive target can be glued to a bottom surface of the rotor. In some embodiments, the conductive target may include a hole having a diameter that is about equal to an outer dimension of the first part.

In some embodiments, the first part of the sensor can be implemented as a pot core that includes at least five coils. In some embodiments, the pot core can include at least five limbs comprising a center limb having an exciting coil and at least four other limbs having measuring coils. In some embodiments, the sensor can include an additional measuring coil positioned around an outer diameter of the pot core. In some embodiments, the radial measurements can be made by the first part and the rotation, tilt, and axial measurements made by the second part. These measurements can be decoupled from each other using the additional measuring coil, for example.

In some embodiments, the second part of the sensor can be implemented as a printed circuit board (PCB) sensor that includes at least eight coils. In some embodiments, the radial measurements made by the first part and the rotation, tilt, and axial measurements made by the second part can be decoupled from each other using signal processing. In some embodiments, rotation, tilt, and axial motions of the rotor do not significantly affect the radial measurements made by the first part. In some embodiments, the radial measurements made by the first part depends on motion of the rotor.

According to another aspect of the present disclosure, a system can include: a rotor; a position sensor configured to fit underneath the rotor, the position sensor having a first plurality of coils and a second plurality of coils; and one or more controllers connected to the position sensor and configured to measure radial position of the rotor using the first plurality of coils and to measure rotation, tilt, and axial of the rotor using the second plurality of coils. The position be provided according to any of the embodiments just described.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is cross-sectional view of a radial position sensor, according to some embodiments.

FIG. 2 is a graph illustrating radial and tilt motion sensitivity of a radial position sensor, according to some embodiments.

FIG. 3A is a perspective view of a radial position sensor configuration, according to some embodiments.

FIG. 3B is a top view of a radial position sensor configuration, according to some embodiments.

FIGS. 4A and 4B are graphs illustrating radial and tilt motion sensitivity of a pot core sensor as a function of target inner radius, according to some embodiments.

FIG. 5A shows a printed circuit board (PCB) that may be used with a radial position sensor, according to some embodiments.

FIG. 5B shows an example of a target that may be attached to a rotor for radial position sensing, according to some embodiments.

FIG. 6A shows a wound pot core that may be used within a radial position sensor, according to some embodiments.

FIG. 6B shows a sensor assembly having a wound pot core and PCB coils, according to some embodiments.

FIG. 7 shows a sensor assembly positioned under a motor, according to some embodiments.

FIGS. 8 and 9 are circuit diagrams showing examples of signal processing that may be used for radial position sensing, according to some embodiments.

FIG. 10 shows a measurement setup for a PCB based sensor, according to some embodiments.

FIG. 11 shows another example of a pot core sensor, according to some embodiments.

FIG. 12 shows an example of a motor system in which a disclosed radial position sensor may be employed.

The drawings are not necessarily to scale, or inclusive of all elements of a system, emphasis instead generally being placed upon illustrating the concepts, structures, and techniques sought to be protected herein.

### DETAILED DESCRIPTION

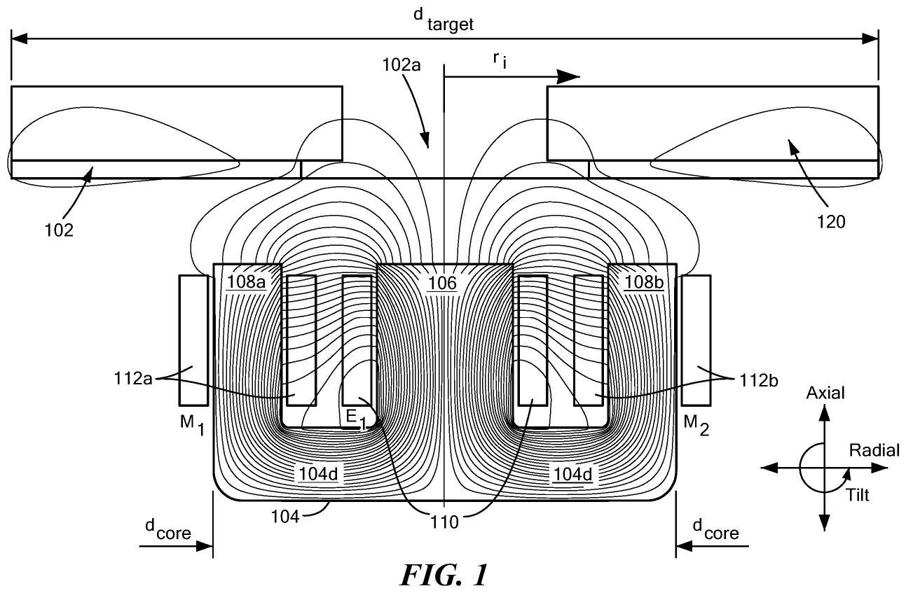

FIG. 1 shows an example of a radial position sensor 100, according to some embodiments. Sensor 100 includes a target 102 and a ferrite core 104 having a middle limb 106 and a plurality of outer limbs 108a, 108b, etc. (108 generally). In some cases, core 104 may be provided as a pot core having one (1) inner limb and four (4) outer limbs. However, in the two-dimensional view of FIG. 1, core 104 may be described as being E-shaped and only two (2) outer limbs 108a, 108b are visible. An excitation coil 110 may be provided around middle limb 104a and measuring coils 112a, 112b, etc. (112 generally) may be provided around respective ones of outer limbs 108a, 108b, etc. Target 102 may be formed from a metal sheet (e.g., an aluminium sheet) and attached (e.g., glued) to a bottom surface of a rotor 120. Target 102 can have a circular shape with diameter d_{target} and can have a hole 102a of radius rᵢ formed in its center. In one example, d_{target} may be about 50 mm and rᵢ may be about 10 mm. Target 102 can extend from middle limb 106 to outer limbs 108.

In FIG. 1, a reluctance-based model is shown on top of the flux lines. Airgap fluxes are shown as reluctances and the flux causing eddy currents are shown as inductive elements (transference). These inductances change with the target motion, thus enabling sensing.

Utilizing a target 102 with a hole 102a in the center can allow for improved measuring the rotor position. The idea is to have a different flux diffusion in the target 102 for radial and tilt motions, and with an appropriate target hole dimensions (e.g., rᵢ), the tilt sensitivity can be reduced for a centered rotor 120 aligned to the sensor 100.

The middle limb 106 ferrite core 104 can be excited with a high frequency sinusoidal voltage (e.g., 10 to 20 kHz) and the differential measurement of the voltages induced in outer limb measuring coils 112 is obtained. The excitation coil 110 and measurement coils 112 can be coupled via magnetic flux in the window and space above the core 104, as illustrated in the figure.

The target 102 attached to the rotor 120 can be positioned above the core 104 such that some part of the airgap flux reaches there and induces eddy currents in the target 102. When target 102 moves in the radial direction, the flux linkage in the coils 112 changes, hence producing differential voltage. The flux linkage variation in the coils 106, 108 due to motion of target 102 can be understood from the transference model of the topology, where the airgap reluctance ( [symbol] _{gap}) and window reluctance ( [symbol] _{window}) will remain almost same, but the transference associated with the target 102 will change. The transference ( [symbol] _{target}) is inversely proportional to the eddy current loss or indirectly to the amount of diffusion in the target 102 (e.g., aluminum sheet target). This transference variation leads to different flux linkages and hence different voltages induced in the outer measuring coils 108.

As illustrated in FIG. 1, the radius target of target 102 may be larger than the radius d_{core}/2 of pot core 104 such that in the centered case, tilt should not have a significant effect on the flux distribution.

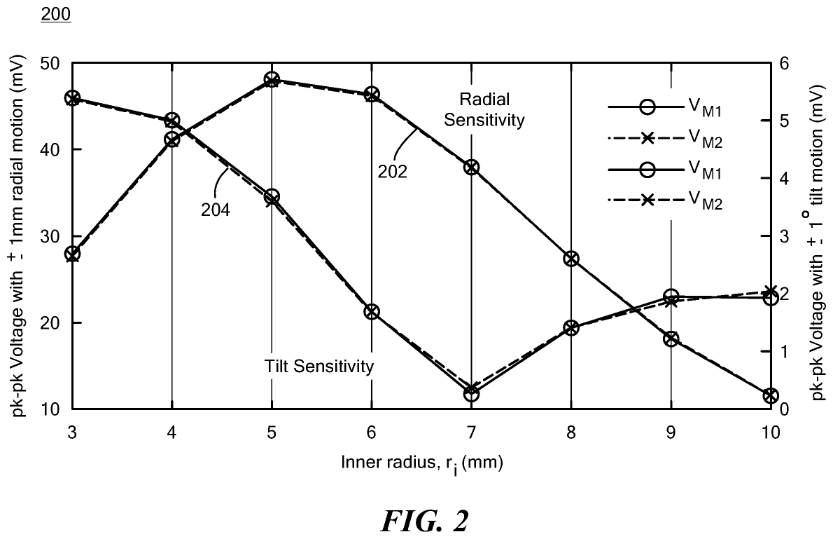

Turning to FIG. 2, the two-dimensional sensor concept illustrated in FIG. 1 can be tested using finite element (FE) simulation to understand the radial and tilt sensitivity behavior with respect to the target dimension. A graph 200 plots radial sensitivity 202 (mV) and tilt sensitivity 204 (mV) for different values of the target hole radius (or “inner radius”) rᵢ. The idea is to have transference variation with the radial motion but not with tilt motion.

The sensitivity plots 202, 204 shown in FIG. 2 can be obtained by moving the target ±1 mm in the horizontal direction and ±1° in the tilt, and recording the induced voltages in the coils. Peak-peak voltages of two measuring coils (M₁ and M₂) are shown, with symmetry causes equal peak-peak voltages for both measuring windings. It can be seen from the figure that there is a best hole radius where the tilt sensitivity minimizes. For example, inner radius, rᵢ=7 mm may minimize tilt sensitivity, allowing an approximately decoupled measurement. This radius value is close to the distance between the centers of inner and outer limbs. There is a trade-off involved in increasing the inner radius since it affects the radial sensitivity as well.

Via simulation, it can be determined that an optimum inner hole radius of the target in may be approximately the distance between the centers of the outer and the inner limbs. The sensitivities in the horizontal axis as well as in the tilt direction can be measured, for example, as 6 V/mm and 0.1 V/° tilt respectively.

The sensor requirements mentioned earlier requires three (3) DoF for control and another three (3) for monitoring. Above, the methodology of the sensor design is discussed which can measure the radial motions without being coupled to tilt motion. Next described are structures and techniques for obtaining a 6-DoF sensor.\

### Pot Core Sensor for X and Y Measurement

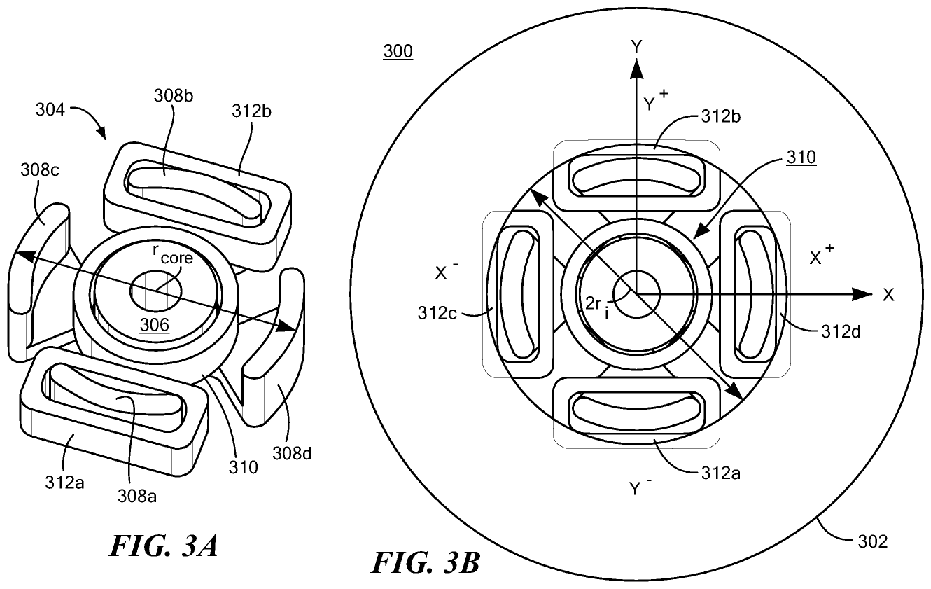

FIGS. 3A and 3B show a radial position sensor 300 configuration, according to some embodiments. FIG. 3A shows a ferrite core 304 with an inner limb 306 having an excitation coil 310 and four (4) outer limbs 308a-d each having a respective one of four (4) measuring coils 312 (only two measuring coils 312a, 312b are shown in FIG. 3A to better illustrate the shape of the ferrite core 304). In one example, excitation coil 310 may have about three hundred (300) turns and has measuring coils 312 may have one hundred (100) turns each using 40 AWG magnet wire. FIG. 3B shows a top view of the sensor 300 with a target 302 and all coils 310, 312a-d.

In some cases, core 304 may have an outer diameter d_{core} of about 18.4 mm and target 302 may have an inner diameter 2rᵢ of about 20 mm. These dimensions may represent optimum decoupled target dimensions where the target hole diameter is close to the pot core outer diameter.

As illustrated in FIGS. 3A and 3B, sensor 300 may be diametrically symmetric so that centered rotor creates zero differential voltage in diametrically opposite coils. Such a structure includes five (5) limbs, one (1) center limb 306 to wind the excitation coil 310 and four (4) limbs 308a-d to accommodate measurement coils 312a-d. A ferrite pot core 304 may be used and machined to fabricate the required structure. Each axis (X and Y) can have two (2) coils to get a differential voltage measurement. In more detail, an X-axis differential voltage measurement can be taken using coils 312c, 312d and a Y-axis differential voltage measurement can be taken using coils 312a, 312b. The target 302 may be rotationally symmetrical to provide the position measurements while the rotor is spinning. Thus, in some cases, target 302 may have a circular shape and be fabricated from a sheet of metal (e.g., an annular aluminium sheet).

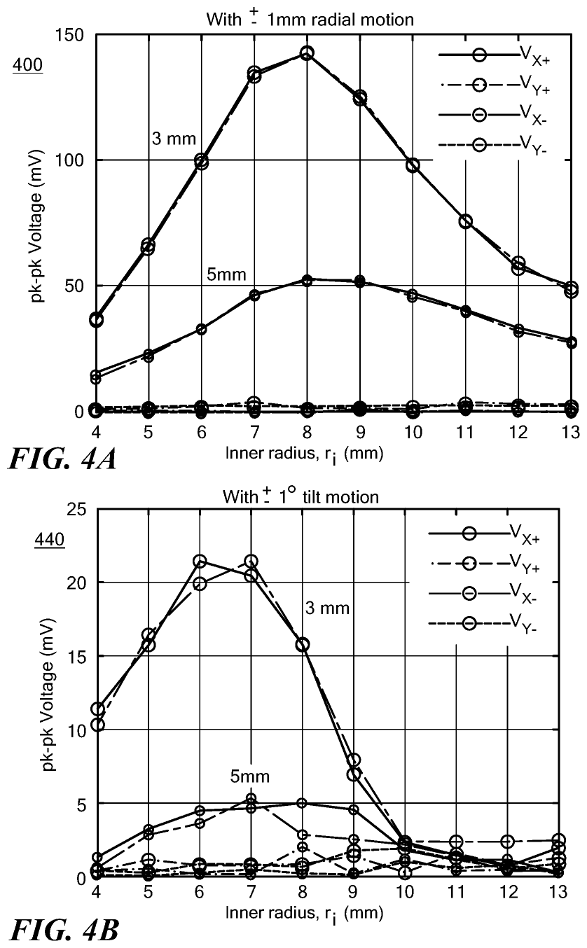

FIGS. 4A and 4B illustrate radial and tilt motion sensitivity of a pot core sensor as a function of target inner radius rᵢ, according to some embodiments. Peak-peak voltage of four (4) measuring coils are shown with 3 mm and 5 mm gap between the target and the sensor. Graph 400 of FIG. 4A shows induced voltage in four (4) coils (X⁺⁻, Y⁺⁻) with ±1 mm radial shift in X direction with 0° tilt. Graph 440 of FIG. 4B shows induced voltage in four (4) coils (X⁺⁻, Y⁺⁻) with ±1° tilt with centered rotor. As can be seen, after rᵢ=10 mm, the induced voltages with tilt are very small in all coils, thus this value may be selected for decoupled measurement. The change in axial gap between target and sensor does not affect the decoupling of radial measurement.

FIGS. 4A and 4B show how the target hole radius rᵢ can be obtained using sensitivity analysis on the target interacting with a pot core-based sensor configuration using finite element (FE) simulations. These results show that a 10 mm inner radius of the target may be an optimum dimension to minimize the tilt sensitivity. The results also match those of FIG. 2 in showing that the target hole diameter close to the outer dimensions of the core may be optimal. Another result is that radial measurement depends on the axial shift. This can be attributed to the nonlinear induced voltage with the axial shift. This does not affect the operation of slice motor, since the axial movement is small. If required, it can be compensated using Z position measurement.

PCB Sensor for Z, θ_{Z}, θ_{X}, and θ_{Y} Measurement

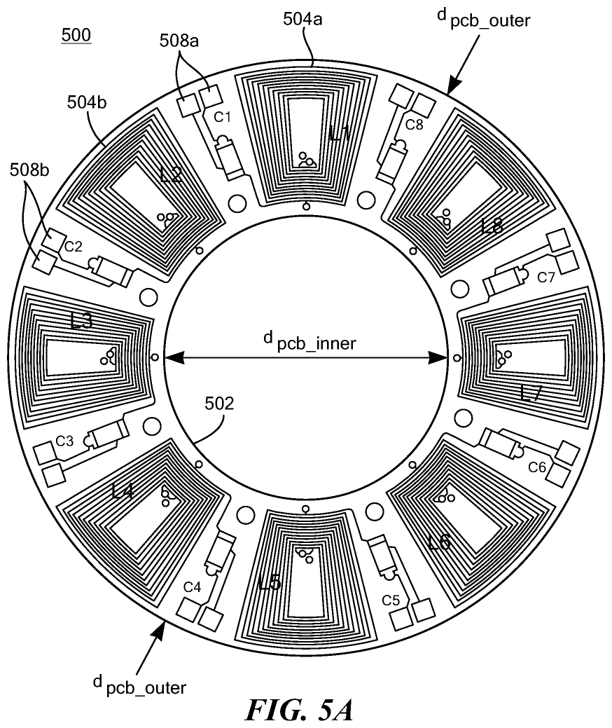

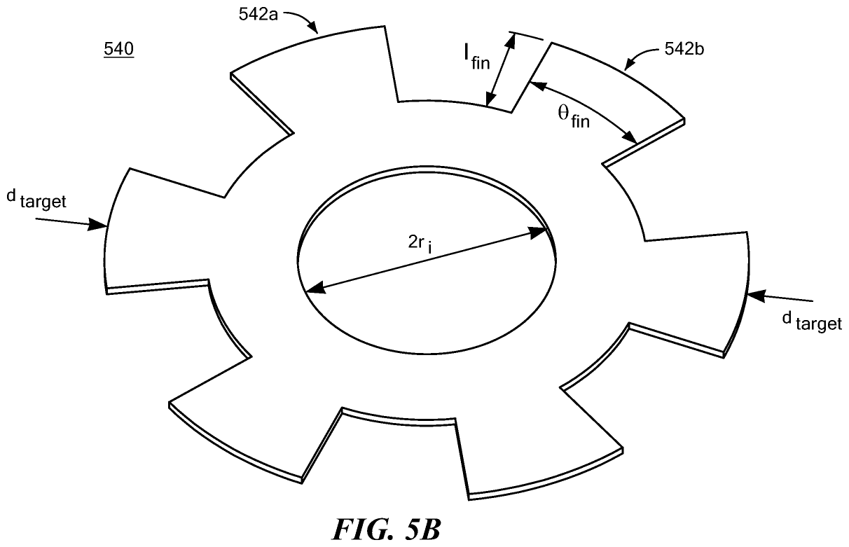

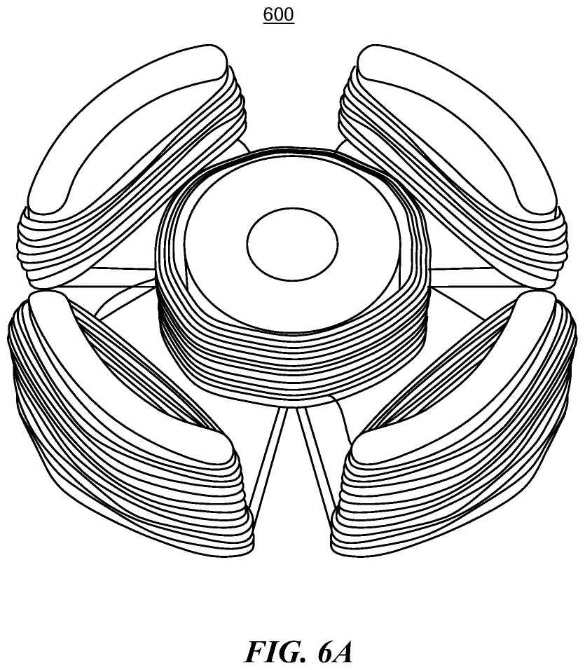

Turning to FIGS. 5A and 5B, an eddy current based sensor 500 can be designed with PCB coils to measure the following four (4) DoF: Z, θ_{Z}, θ_{X}, and θ_{Y}. That is, a pot core sensor, such as illustrated in FIGS. 3A and 3B may be used to measure X and Y motions whereas sensor 500 may be used to measure Z, θ_{Z}, θ_{X} and θ_{Y}.

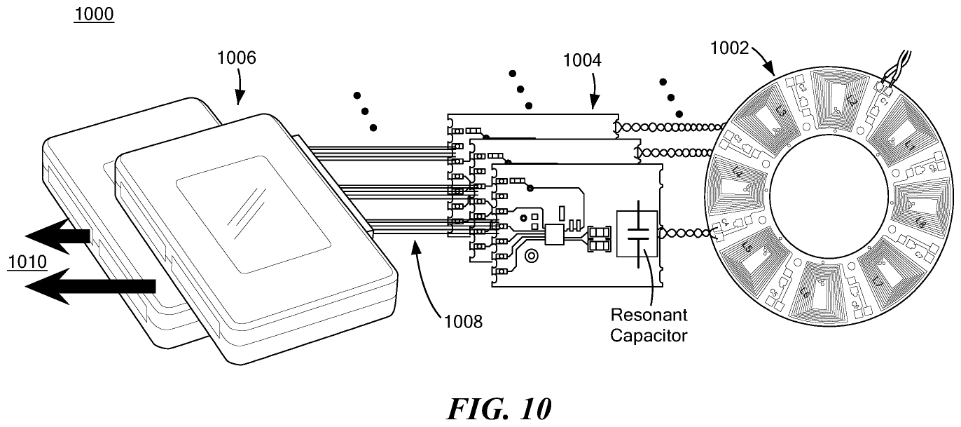

In FIG. 5A, a PCB 502 may be provided with symmetrically arranged coils 504a, 504b, etc. (504 generally) each connected to a resonant capacitor and to a processing integrated circuit (IC) via contacts 508a, 508b, etc. In some examples, there are eight (8) coils 504 (L1-L8) and eight (8) corresponding resonant capacitors and ICs such as illustrated in FIG. 10, for example. In some embodiments, the IC may be an LDC1101 from TEXAS INSTRUMENTS. PCB 502 may have an outer diameter d_{pcb_outer} of about 50 mm and an inner diameter d_{pcb_inner} of about 24 mm.

FIG. 5B shows an illustrative target 540 that may be used with sensor 500 of FIG. 5A. Target 540 may, for example, be waterjet cut from a sheet of 6061 aluminium alloy. Target 540 may have an outer diameter d_{target} selected to match that of a rotor to which is attached (e.g., 50 mm) and may have an inner hole radius r; (e.g., 10 mm) and outer fins 542a, 542b, etc. (542 generally) having length l_{fin} (e.g., 7 mm long) and arc θ_{fin} (e.g., 30°). The fins 542 of target 540 are salient features that interact with the PCB coils 504, whereas the inner periphery of target 540 interacts with a ferrite core, such as the pot core illustrated in FIGS. 3A and 3B.

Illustrative sensor 500 works on the principle of inductance variation of the coils 504 due to variation in flux linkage caused by the amount of induced eddy current in nearby target (e.g., target 540 attached to a bottom of a rotor positioned above sensor 500). The motion of the conductive target 540 causes inductance variation of the PCB coils 504 and the position can be estimated using this variable inductance measurement.

To generate the inductance variation in the PCB coils 504 due to the four (4) DoF motions, θ_{Z}, θ_{X}, and θ_{Y}, fins 542 are provided to the outer periphery of the aluminium target 540. Since a motor can have a salient pole rotor with N teeth, N fins 542 may be used since these fit under the rotor teeth. In some cases, N=6. For θ_{Z} measurement, sin(θ_{Z}) and cos(θ_{Z}) may be computed, as discussed further below. For the PCB design of FIG. 5A, the spacing between the coils may be such that some of the coils provide sine output and some of these provide cosine output with rotor angular motion.

With a 12-pole rotor, nπ/2 (n∈odd integer) phase shift between sine and cosine signals will convert to nπ/12 spatial shift between coils measuring sine and cosine signals. This leads to the 8-coil PCB design with π/4 (45°, n=3) spatial shift between coils, such as illustrated in FIG. 5A. This way each PCB coil 504 provides either a sine or cosine signal with either polarity, which can enhance the sensitivity and reduce coupling to the tilt and axial motions. Moreover, this 6-fin and 8-coil design makes it convenient to obtain directly the electrical angle, in the case of a motor having a 12-pole rotor.

The inductance of the PCB coils 504 can vary if the distance of the target is varied from the sensor or the overlapping area between a fin 542 and a PCB coil 504 is changed. Both these phenomena may be used to measure the position in four (4) DoF using multiple coils.

The inductance variations can be converted into voltages and are calibrated to use for various position measurements. Using these voltages from all the eight (8) coils 504 (L1-L8), different DoF positions can be estimated as follows:

$$sin ( {θ}_{Z} ) = {k}_{1} ( {L}_{2} + {L}_{6} - {L}_{4} - {L}_{8} ) \qquad ( 1 )$$

$$cos ( {θ}_{Z} ) = {k}_{2} ( {L}_{1} + {L}_{5} - {L}_{3} - {L}_{7} )$$

$${θ}_{X} = {k}_{3} ( {L}_{1} + {L}_{2} + {L}_{8} - {L}_{4} - {L}_{5} - {L}_{6} )$$

$${θ}_{Y} = {k}_{4} ( {L}_{6} + {L}_{7} + {L}_{8} - {L}_{2} - {L}_{3} - {L}_{4} )$$

$$Z = {k}_{5} ( {L}_{1} + {L}_{2} + {L}_{3} + {L}_{4} + {L}_{5} + {L}_{6} + {L}_{7} + {L}_{8} )$$

where Lᵢ, (i∈1-8) is the measured PCB coil inductance of the i^{th} coil and a first coil (e.g., coil 504a) is aligned to the Y axis. In equations (1), kⱼ, (j∈1-5) is calibration factor used to convert inductance value to voltage to use in the control.

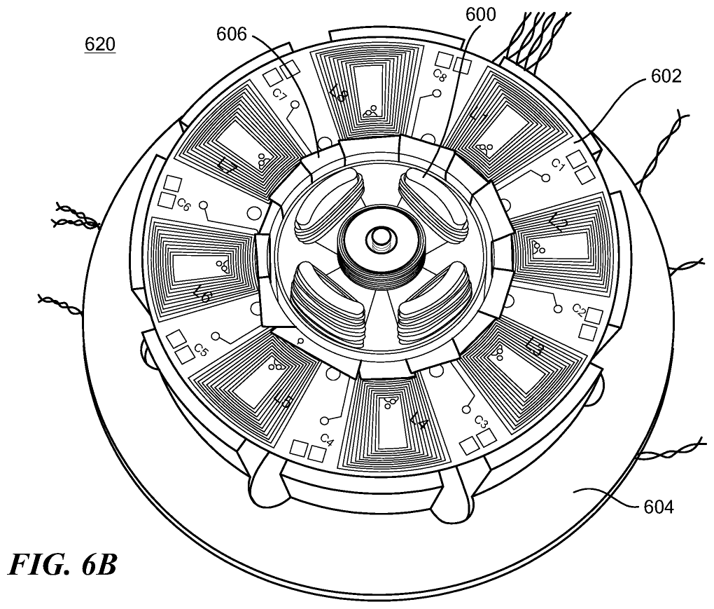

Turning to FIGS. 6A and 6B, after assembling all the sensor parts in a fabricated sensor retainer, the complete sensor is arrived at. The complete sensor may be fabricated to mate with the motor base and align with the stator bore with an adjustable gap between the sensor and the rotor. FIG. 6A shows an example of a wound pot core 600. FIG. 6B shows a sensor assembly 620 having the wound pot core 600 and a PCB 602 with coils, all within a retainer 604 (e.g., a metal structure fabricated to hold pot core 600 and PCB 602). A copper foil cylindrical shield and the copper foil 606 may be provided at the inner periphery of PCB 602 to shield the pot core 600 from PCB flux.

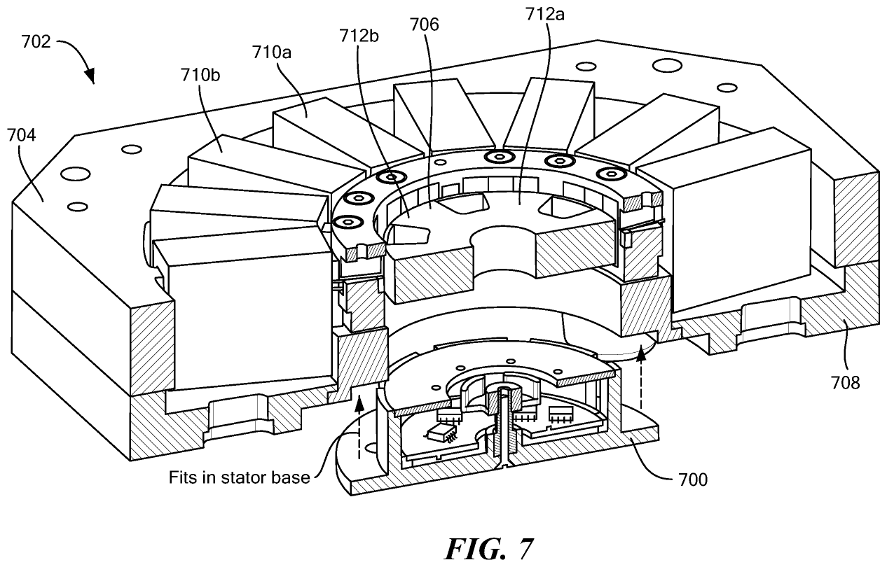

FIG. 7 shows a sensor assembly 700 positioned under a motor 702, according to some embodiments. Illustrative motor 702 includes a stator 704 a rotor 706. Stator 704 includes a base 708 and a plurality of teeth 710a, 710b, etc. (710 generally) each with one or more coil windings. Rotor 706 includes a plurality of salient features 712a, 712b, etc. (712 generally), here shown as rotor teeth. A conductive target (not shown) may be attached (e.g., glued) to a bottom surface of rotor 706. As shown, sensor assembly 700 may be designed to fit in the stator base 708 right under the rotor 706 with target.

### Signal Processing

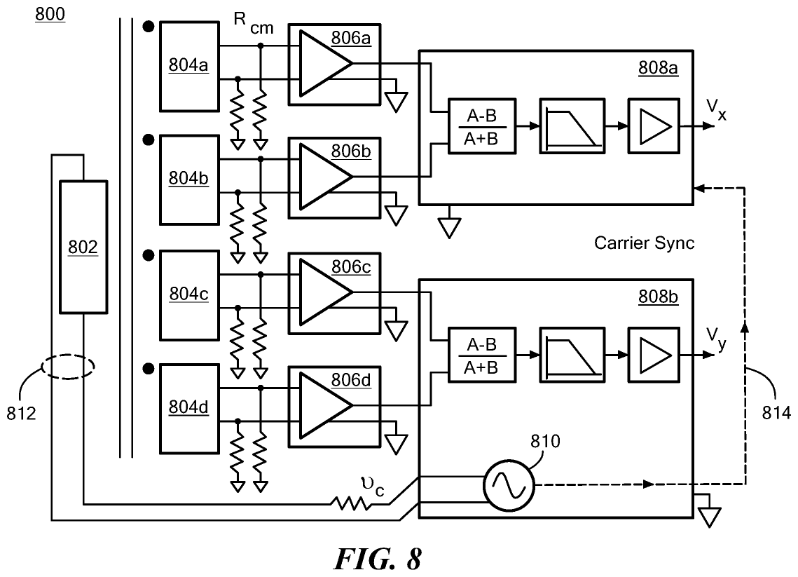

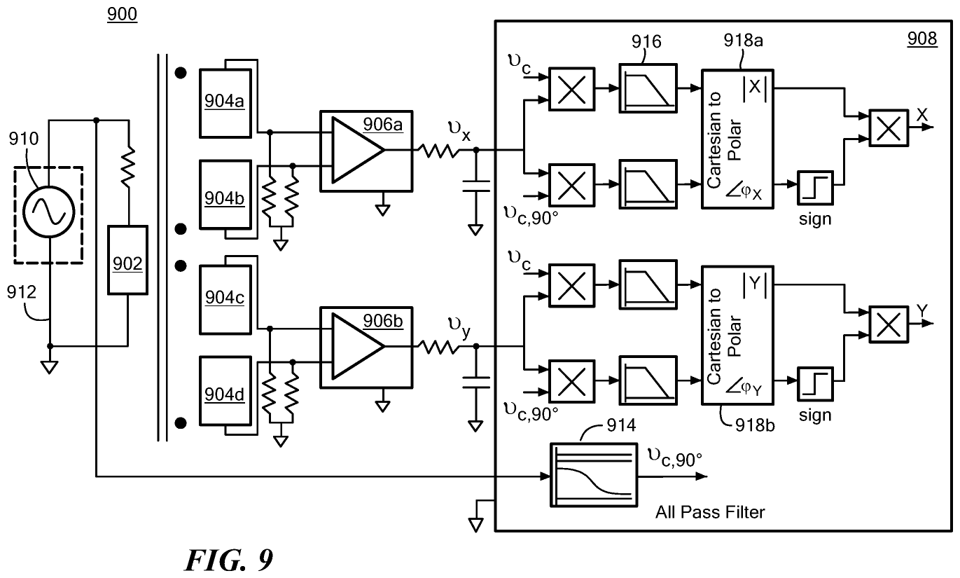

Turning to FIGS. 8 and 9, according to some embodiments, both parts of a sensor (e.g., a pot core part and a PCB part) can operate using eddy current principle, but the methods to obtain position from these may differ. Both sensor parts require circuits for excitation power supply, signal conditioning, and signal processing. Such circuits and related techniques are described next.

### Signal Processing for X and Y Measurements

The operating principle of a disclosed pot core sensor can be explained as follows. The voltage induced in the diametrically opposite measuring coils are modulated by the motion of the target attached to the rotor. In other words, with the motion of the rotor, the induced voltages in measuring coils vary and this variation is an estimate of the position. One way to estimate the position is by calculating the difference in amplitudes of the induced voltages in diametrically opposite coils. Other methods are available which may be more immune to noise. Two methods are tested for X/Y position measurement and they are explained here.

FIG. 8 shows a signal processing arrangement 800 that may be used for X/Y position measurement, according to some embodiments. Illustrative signal processing arrangement 800 includes excitation coil 802, four (4) measurement coils 804a-d (804 generally), four (4) respective instrumentation amplifiers 806a-d (806 generally), and two signal conditioner ICs 808a,b (8080 generally), which components can be connected as shown.

Since the operation of the pot core sensor is similar to a linear variable differential transformer (LVDT), signal conditioner ICs may be provided as LVDT signal conditioner ICs and, in some cases, as AD598 signal conditioner ICs from ANALOG DEVICES. One of the signal conditioner ICs 808b may include an oscillator 810 to generate excitation signal 812 (e.g., a 10 kHz excitation signal). Both of the signal conditioner ICs 808 may be configured to measures two (2) signals from diametrically opposite measuring coils 804 and process these signals to provide the differential voltage of the coils, i.e. output voltage Vₓ or V_{y}.

The induced voltage from the sensor's measuring coils 804 may be relatively small, thus instrumentation amplifiers 806 can be used as a front end before sending the signals to the ICs 808. This amplifies the raw signal which makes it easier for the IC for further processing. Since there are four (4) coils 804, four (4) instrumentation amplifiers 806 may be used. Since the coils are floating with respect to the circuit ground, common mode resistors R_{cm} (or “bleed resistors”) may be connected to both wires of each measuring coil 804 to provide path for amplifier bias currents. In some cases, R_{cm} may be about of 100 kΩ. In some cases, the two signal conditioner ICs 808 may be synchronized via the excitation/carrier signal 812, as shown by dotted line 814.

Turning to FIG. 9, as mentioned earlier, the motion of the target can vary the induced voltages in the coils. This voltage variation in the coil can be considered as a modulating signal for the high frequency excitation voltage which is considered as a carrier signal here. For this modulated signal, a synchronous demodulation method is used to extract the modulating signal from the induced voltages. This method is proven to have good performance in the presence of noise. The demodulation algorithm may be implemented in a field programmable gate array (FPGA). In some cases, with the carrier frequency of around 15 kHz, an FPGA analog input module with 1 MSamples/sec capability may be used, but the algorithm can be implemented at 800 kHz owing to the processing time.

Illustrative signal processing arrangement 900 includes excitation coil 902, four (4) measurement coils 904a-d (904 generally), two (2) instrumentation amplifiers 906a,b (906 generally) each connected to a pair of measurement coils 904, a FPGA 908, and an oscillator 910 that may be provided, for example, by a signal conditioner IC (e.g., an AD598 IC). These components may be connected as shown in the figure.

As shown, differential voltages from X and Y coils can be amplified using instrumentation amplifiers 906 and these voltages are sent to analog input modules along with the excitation signal 912. Excitation signal 912, being the least noisy signal, can be used as the carrier signal v_{c}. A digital all-pass filter 914 can be implemented to obtain the quadrature carrier signal v_{c,90°}. A low pass filter (LPF) present in the demodulation algorithm (e.g., LPF 916) may have the smallest bandwidth, thus defining the bandwidth of the sensor. In some cases, such a LPF may have a cutoff frequency of 1 kHz; the position loop is working close to 100 Hz and a sensor bandwidth of 10 times the loop bandwidth may be suitable for control design. The carrier signal v_{c} quadrature carrier signal v_{c,90°} may be used to generate inputs (filtered by the LPFs) to cartesian-to-polar blocks 918a,b, which in turn can provide output voltages Vₓ and V_{y}, as shown.

In some embodiments, instrumentation amplifiers 906 may be provided as LT1167 amplifiers from ANALOG DEVICES. In some embodiments, FPGA 908 may be configured to operate at 800 kHz.

Signal Processing for Z, θ_{Z}, θ_{X} and θ_{Y} Measurement

FIG. 10 show a signal processing arrangement 1000 for measuring Z, θ_{Z}, θ_{X} and θ_{Y}, according to some embodiments. A PCB sensor 1002 can have eight (8) coils made of copper traces on a four (4) layer PCB. Each coil may have an inductance of about 34.5 μH, in some examples. The inductance variations of the PCB coils, induced by moving target, can be measured using inductance-to-digital converter (LDC) ICs, which may be provided as LDC1101's made by TEXAS INSTRUMENTS. In some cases, eight (8) LDC ICs 1004 may be used, one for each PCB coil.

An LDC IC 1004 can estimate the inductance by finding the resonance frequency of a parallel LC resonant circuit comprised of a respective PCB coil inductor and an external capacitor. Since all these PCB coils are relatively close to each other, if their resonant tank frequencies are also close to each other, a coupled resonance phenomenon can cause significant interference between coils and generate wrong inductance measurements. This can be avoided, for example, by setting the resonance frequencies for all the resonant tanks different by using different capacitor values for resonant tanks. In some embodiments, the different capacitor values used may be 70, 100, 120, 150, 180, 200, 220, 247 pFs.

These LDC ICs 1004 can be connected to communicate with one or more FPGAs 1006 via an SPI (Serial Peripheral Interface) protocol 1008 to obtain inductance values by reading specific registers. In some cases, two (2) FPGAs 1006 may be used. In some embodiments, FPGAs 1006 may be provided as NATIONAL INSTRUMENT (NI) myRIO FPGAs. Then FPGAs can generate eight (8) analog output voltages 1010 corresponding to that inductance values which is sent to analog output channels of the FPGAs 1006. From there, these eight (8) analog voltages 1010 can be sent to a main FPGA (e.g., a NI cRIO, not shown) where control and monitoring algorithms are implemented. That is, analog voltages 1010 can be sent to a main controller for 4-DoF position calculation.

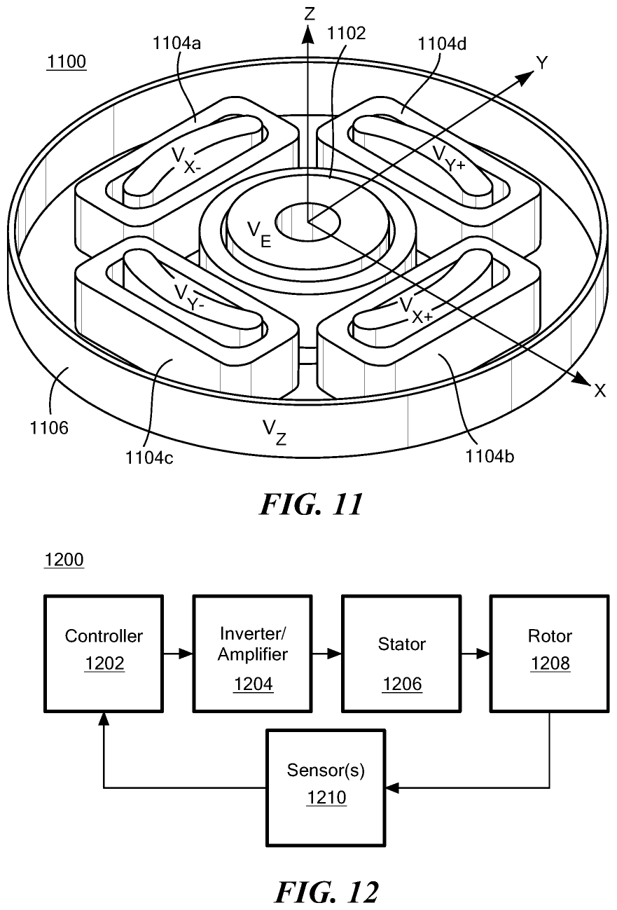

Turning to FIG. 11, according to some embodiments, a pot core sensor 1100 having five (5) limbs and six (6) windings may be used within a radial position sensor. An inner coil 1102 corresponds to the excitation coil, four (4) coils 1104a-d on the four (4) legs are radial motion measuring coils, and an outermost coil 1106 is for axial motion measurement. Outermost coil 1106 may surround the whole sensor 1100 to measure the axial position of the rotor.

FIG. 12 shows an example of a motor system 1200 in which a disclosed radial position sensor may be employed, according to some embodiments. Illustrative system 1200 includes a controller 1202, one or more inverters/amplifiers 1204, stator 1206, rotor 1208, and one or more sensors 1210. Controller 1202 can generate one or more control signals (e.g., levitation/suspension control signals and/or speed control signals) to excite the coils of stator 1206. In turn, stator 1206 can generate flux to turn rotor 1208. The one or more sensors 1210 can detect position of the rotor 1208 and provide such position information as feedback to controller 1202. Sensors 1210 can include, for example, a sensor that combines a pot core sensor, a PCB sensor, and signal processing circuitry configured for 6-DoF sensing, according to embodiments of the present disclosure.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory, in a digital signal processor (DSP), and/or in a discrete electronic circuit, which can be analog or digital. A processor or controller can include internal processors or modules that perform portions of the function, operation, or sequence of operations. Similarly, a module can include internal processors or internal modules that perform portions of the function, operation, or sequence of operations of the module. A single processor or other unit may fulfill the functions of several means recited in the claims.

As used in the claims or elsewhere herein, the term “comprising” does not exclude other elements or steps, and the indefinite article “a” or “an” does not exclude a plurality.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the claims, detailed description, and drawings. These connections and/or positional relationships, unless specified otherwise, can be direct or indirect, and the claimed inventions are not intended to be limiting in this respect. Accordingly, a coupling/connection of entities can refer to either a direct or an indirect coupling/connection, and a positional relationship between entities can be a direct or indirect positional relationship. As an example of an indirect positional relationship, references in the present description to element or structure A coupled/connected to element or structure B include situations in which one or more intermediate elements or structures (e.g., element C) is provided between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the detailed description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Other variations to the disclosed embodiments can be understood and effected by those skilled in the art in practicing the claimed invention, from a study of the drawings, the disclosure, and the appended claims.

The mere fact that certain measures are recited in mutually different dependent claims does not indicate that a combination of these measures cannot be used to obtain an advantage. Any reference signs in the claims should not be construed as limiting the scope.

All publications and references cited herein are expressly incorporated herein by reference in their entirety.

1. A position sensor configured to sense information about a position of a rotor, the position sensor comprising:
a first part comprising a plurality of coils, the first part configured to make radial measurements related to the rotor; and
a second part comprising a plurality of coils, the second part configured to make rotation, tilt, and axial measurements related to the rotor,
wherein the position sensor is configured to fit underneath the rotor.

2. The position sensor of claim 1 wherein the position sensor is a 6-degrees of freedom (DoF) position sensor.

3. The position sensor of claim 1 wherein the rotor is part of a bearingless slice motor.

4. The position sensor of claim 1 wherein the position sensor is configured to interact with a conductive target affixed to the rotor.

5. The position sensor of claim 4 wherein the conductive target is glued to a bottom surface of the rotor.

6. The position sensor of claim 4 wherein the conductive target includes a hole having a diameter that is about equal to an outer dimension of the first part.

7. The position sensor of claim 1 wherein the first part is implemented as a pot core that includes at least five coils.

8. The position sensor of claim 7 wherein the pot core includes at least five limbs comprising a center limb having an exciting coil and at least four other limbs having measuring coils.

9. The position sensor of claim 8 comprising an additional measuring coil positioned around an outer diameter of the pot core.

10. The position sensor of claim 9 wherein the radial measurements made by the first part and the rotation, tilt, and axial measurements made by the second part can be decoupled from each other using the additional measuring coil.

11. The position sensor of claim 1 wherein the second part is implemented as a printed circuit board (PCB) sensor that includes at least eight coils.

12. The position sensor of claim 1 wherein the radial measurements made by the first part and the rotation, tilt, and axial measurements made by the second part can be decoupled from each other using signal processing.

13. The position sensor of claim 12 configured such that rotation, tilt, and axial motions of the rotor do not significantly affect the radial measurements made by the first part.

14. The position sensor of claim 1 configured such that the radial measurements made by the first part depends on motion of the rotor.

15. A system comprising:
a rotor;
a position sensor configured to fit underneath the rotor, the position sensor having a first plurality of coils and a second plurality of coils; and
one or more controllers connected to the position sensor and configured to measure radial position of the rotor using the first plurality of coils and to measure rotation, tilt, and axial of the rotor using the second plurality of coils.

16. The system of claim 15 wherein one or more controllers are configured to perform the radial position measurement independent of the rotation, tilt, and axial measurement.

17. The system of claim 15 wherein the first plurality of coils are provided on a pot core.

18. The system of claim 17 wherein the pot core includes at least five limbs comprising a center limb having an exciting coil of the first plurality of coils and at least four other limbs having measuring coils of the first plurality of coils.

19. The system of claim 18 comprising an additional measuring coil first plurality of coils positioned around an outer diameter of the pot core.

20. The system of claim 15 wherein the second plurality of coils include at least eight coils provided on a printed circuit board (PCB).
